(19) United States
(12) Patent Application Publication
(10) Pub. No.: US 2014/0043087 A1
(43) Pub. Date: Feb. 13, 2014

(54) HIGH ACCURACY BIPOLAR CURRENT MULTIPLIER WITH BASE CURRENT COMPENSATION

(71) Applicants: Yan Li, Shanghai (CN); Xuemin Yang, Edna, MN (US)

(72) Inventors: Yan Li, Shanghai (CN); Xuemin Yang, Edna, MN (US)

(73) Assignee: LSI Corporation

(21) Appl. No.: 13/569,672

(22) Filed: Aug. 8, 2012

(51) Int. Cl. G06G 7/16

(52) U.S. Cl. 327/358

(57) ABSTRACT

A bipolar current multiplier apparatus and method includes a group of negative feedback loop circuits for compensating base current loss, and multiple bipolar devices that communicate electronically with the negative feedback loop circuits, wherein the bipolar devices are responsive to base currents capable of being self-cancelled due to a presence of the negative feedback loop circuits, thereby ensuring that an output is stabilized over temperature and process variations while providing for a wide input dynamic range. In some embodiments, the bipolar current multiplier apparatus can be associated with a preamplifier for a hard disk drive to calculate the output power associated with a power driver that controls the flying height of read/write heads of the hard disk drive.

### TECHNICAL FIELD

Embodiments are generally related to hard disk drive technology. Embodiments are also related to bipolar multiplier circuits.

### BACKGROUND OF THE INVENTION

As hard disk technology advances, the clearance between the signal reading/writing heads and disk surface becomes smaller. Generally, a flying height control circuit is required in a preamplifier to precisely place the read/write head above disk surface. With the decrease of the clearance, however, the flying height control circuit has to be more accurate and stable over all a number of variations such as, for example, temperature, supply, and process.

Furthermore, it is known that the flying height is proportional to the power consumption that is applied to a heater resistor near the read/write heads. In order to control the flying height in a linear manner, the power on the heater resistor has to be well controlled, and as a result, a multiplier is required to combine the output voltage and current into power.

FIG. 1 illustrates a schematic diagram of a bipolar multiplier circuit 10 implemented by a translinear loop that has been implemented in the context of a hard disk drive. The circuit 10 shown in FIG. 1 generally includes a current source 16 electrically connected to a transistor 18 and a transistor 20. Transistor 18 and transistor 20 are also electrically connected to a transistor 24. Both transistor 24 and transistor 20 are connected to a current source 26. Transistor 24 is further connected to a transistor 28, which in turn is connected to a current source 30 and a transistor 32. Note that transistor 20, current source 26, current source 30, and transistor 32 are further connected to ground. Current source 16, transistor 18, transistor 24, and transistor 28 are each also connected to a voltage source (e.g., Vcc). A current 34 is also provided to transistor 32. Legend 12 shown in FIG. 1 indicates equations associated with the operations of circuit 10. Additionally, an ideal multiplier equation is shown in FIG. 1 above legend 12.

Circuit 10 is presented to demonstrate the problems associated with prior art multiplier circuits. The Bipolar multiplier circuit 10 shown in FIG. 1 can be utilized in a preamplifier for a hard disk drive to calculate the output power of the power driver that is used to control the flying height of the read/write heads. Basically, three currents 16, 26, 30 (respectively, also labeled as I1, I2, I3) are the inputs to the multiplier circuit 10, while the current 34 (also labeled as I4) is the output of the multiplier circuit 10.

Because the collector current of a bipolar device follows exponential function of the base emitter voltage V_{be} (See equation 1 for V_{be} in the legend 12), and the sum of the V_{be} voltage of transistors 20 and 24 equals to the sum of V_{be} voltage of transistors 28 and 32 (See equation 2 in legend 12) as a result, when equally sized bipolar devices are employed to construct the multiplier circuit 10 shown in FIG. 1, based on equations 1 and 2 shown in legend 12, the multiplication of the two collector currents I_{c1}*I_{c2} will be equal to the multiplication of the other two collector currents I_{c3}*I_{c4}.

For the circuit 10 shown in FIG. 1, I_{c1} is equal to I1, I_{c2} approximates to I2, I_{c3} approximates to I3 and I_{c4} is equal to I4. As for a bipolar device, a base current exists and flows from its base to emitter (e.g., NPN, opposite direction for PNP). In general, the transistor 18 (i.e., M4) is employed to remove the base currents effect on input I1. In such a case, transistors 18, 20, and 24 (respectively, M4, q1 and q2) form a closed loop and the base currents of transistors 24 and 28 (respectively, q2 and q3) are provided by the drain current of transistor 18 (i.e., M4). When the base currents of transistors 20, 24, 28, and 32 (i.e., q1 to q4) are introduced into equation 3 shown in legend 12, the equation 5 shown in legend 12 can be obtained and used to implement the ideal multiplier function I1*I2=I3*I4.

The base currents result in inaccuracies with respect to equation 3 when the beta of bipolar devices is not large enough. Generally, a beta between bipolar devices demonstrates a large mismatch and variations across factors such as process and temperature. As a consequence, the prior art multiplier circuit 10 of FIG. 1 is no longer favorable for current and future preamp applications that continually require very high precision across wider environmental changes such as, for example, temperature and supply variations.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved bipolar current multiplier apparatus and method.

It is another aspect of the disclosed embodiments to provide for a bipolar current multiplier apparatus and method that includes the use of a group of negative feedback loop circuits.

It is a further aspect of the disclosed embodiments to provide for a bipolar multiplier apparatus and method that stabilize and improve output over variations in temperature and process factors, while providing for a wide input dynamic range.

The aforementioned aspects and other objectives and advantages can now be achieved as described herein. A bipolar current multiplier apparatus is disclosed, which includes a plurality of negative feedback loop circuits for compensating base current loss, and a plurality of bipolar devices that communicates electronically with the plurality of negative feedback loop circuits, wherein the plurality of bipolar devices are responsive to base currents capable of being self-cancelled due to a presence of the plurality of negative feedback loop circuits, thereby ensuring that the output is stabilized over temperature and process variations while providing for a wide input dynamic range. In some embodiments, the bipolar current multiplier apparatus can be associated with a preamplifier for a hard disk drive to calculate the output power associated with a power driver that controls a flying height of read/write heads of the hard disk drive.

In a preferred embodiment, the plurality of negative feedback loop circuits comprises two negative feedback loops incorporated into the bipolar current multiplier apparatus. In some embodiments, the bipolar devices can be provided as bipolar transistors. Each negative feedback loop among the plurality of negative feedback loop circuits is independent of one another and capable of being tuned separately from one another. Additionally, an emitter current associated with at least one bipolar device among the plurality of bipolar devices is auto-adjustable by at least one negative feedback loop among the plurality of negative feedback loop circuits and at least two bias currents. Each bipolar device preferably comprises a NPN device. In some embodiments, however, the current source (or current sources) providing electrical current to the plurality of negative feedback loop circuits and the plurality of bipolar devices can constitute a bipolar current source or a MOS current source.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic diagram of a prior art bipolar multiplier circuit implemented by a translinear loop; and

FIG. 2 illustrates a schematic diagram of a bipolar multiplier circuit with base current compensation, in accordance with a preferred embodiment.

### DETAILED DESCRIPTION

The particular values and configurations discussed in these non-limiting examples can be varied and are cited merely to illustrate at least one embodiment and are not intended to limit the scope thereof.

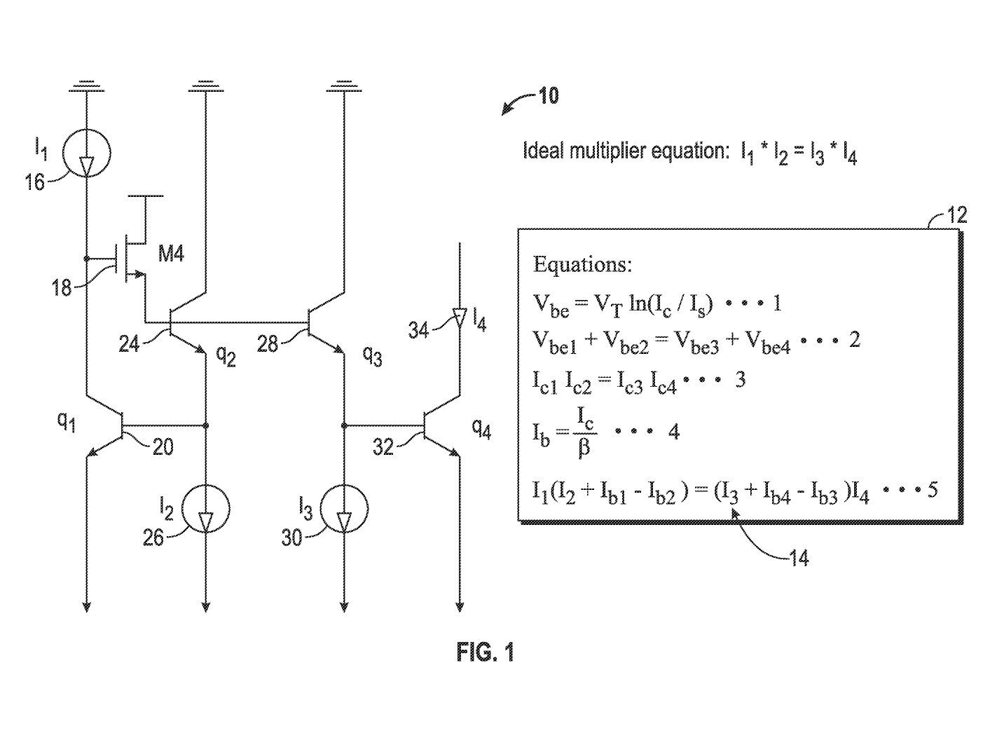

In general, due to base current leakage, prior art bipolar multiplier circuits such as the example shown in FIG. 1 have become incapable of fulfilling the task of precisely controlling the flying height associated with a hard disk drive with less variation, particularly for temperature variations due to the inherent base current. The disclosed embodiments thus provide a solution to these and other problems in the form a new bipolar multiplier that can be configured with negative feedback loops to compensate for the base current loss. As will be explained in greater detail, such an improved multiplier circuit becomes more stable and robust over temperature, supply, and environmental changes. This improved circuit design offers superior linear capabilities together with a much wider input dynamic range.

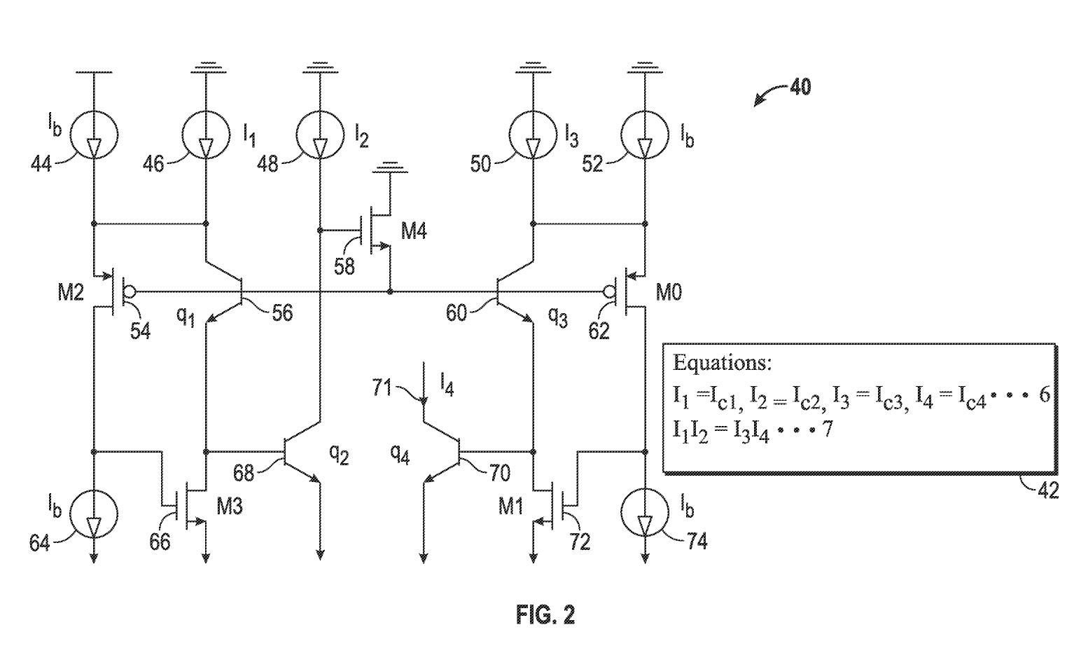

FIG. 2 illustrates a schematic diagram of a bipolar multiplier circuit 40 with base current compensation, in accordance with a preferred embodiment. The multiplier circuit 40 shown in FIG. 2 includes a number of current sources or currents 44, 46, 48, 50, 52 (also, respectively labeled as I_{b}, I₁, I₂, I₃, I_{b}) and current sources or currents 64 and 74 (also, respectively labeled as I_{b} and I_{b}). A number of transistors 54, 56, 58, 60, and 62 (also, respectively labeled as M2, q₁, M4, q₃, M0) are also included as a part of the multiplier circuit 40. Additionally, transistors 66, 68, 70, and 72 (also, respectively, labeled as M3, q², q₄, M1) form a part of the multiplier circuit 40. A legend 42 shown in FIG. 2 includes equations 6 and 7 with respect to the electrical operation of multiplier circuit 40.

In the configuration shown in FIG. 2, two negative feedback loops are incorporated into the bipolar multiplier circuit 40 by introducing transistors 62, 72, 54, 66 (i.e., M0, M1, M2, M3) and four bias currents 44, 52, 64, and 74 having the same current value I_{b}. The two negative feedback loops are independent of one another and can be tuned separately. Different from normal bipolar multiplier, inputs I₁, I₂, and I₃ each go to the collector sides of the bipolar devices, and as a result, equation 6 shown in legend 42 is always satisfied.

The emitter current of transistor 60 (i.e., q₃) can be auto-adjusted by a negative feedback loop including devices 72, 62 (i.e., respectively M1, M0) and two bias currents I_{b}. When there is current difference between the collector current of transistor 60 (i.e., q₃) and the input I₃, there will be extra current flowing into or out of source of transistor 62 (i.e., M0). Because the gate node of transistor 72 (i.e., M1) is a high impedance node, the small current flow will introduce large voltage change at the gate node of transistor 72, and this gate voltage change results in emitter current change of transistor 60. Due to the negative loop characteristic, the collector current of transistor 60 will be forced to be equal to the input current 50 (i.e., I₃).

For example, suppose initially that the input current 50 is higher than the collector current of transistor 60. There will be a positive current from the supply to the gate node of transistor 72. Because this node operates with a high impedance, injection of the current will raise the node voltage to an even higher potential. The higher gate voltage results in larger current flow from drain to source of transistor 72, or the emitter current of transistor 60, and eventually the collector current of transistor 60 is increased to equal to input current 50 (i.e., I₃).

Because the source node of transistor 62 (i.e., M0) is a low impedance node that equals to 1/gm, where gm is the trans-conductance of transistor 62, the loop is much easier to be stabilized by adding some capacitor to the dominate pole at the drain node of transistor 62. For the other loop, the dominate pole is at the drain of transistor 54 (i.e., M2).

Due to the function of the negative feedback loop, the base current effect of both transistors 60 and 70 can be eliminated. The same process is applied to the negative feedback loop including devices 54, 66, and two current biases. Therefore, the multiplier equation I1*I2=I3*I4 is well established by the invention. When the multiplier is incorporated with the negative feedback bops, its input, output range, accuracy, and stability will all be improved. This configuration will be very helpful for application to the next generation of preamp devices, circuits, and components utilized with, for example, hard disk drives.

Note that the bipolar devices in shown FIG. 2 are NPN devices and BICMOS technology is generally used to implement the embodiment shown in FIG. 2. It can be appreciated, however, that the disclosed embodiments can also be implemented with or in the context of a PNP multiplier circuit. The current sources can be either bipolar or MOS current sources. Bipolar devices can also replace the MOS devices so that alternative embodiments can also be employed with bipolar technology.

Based on the foregoing, it can be appreciated that a number of embodiments, preferred and alternative, are disclosed herein. For example, in one embodiment, a bipolar current multiplier apparatus can be implemented, which includes, for example, a plurality of negative feedback loop circuits for compensating base current loss, and a plurality of bipolar devices that communicates electronically with the plurality of negative feedback loop circuits, wherein the plurality of bipolar devices are responsive to base currents capable of being self-cancelled due to a presence of the plurality of negative feedback loop circuits, thereby ensuring that an output is stabilized over temperature and process variations while providing for a wide input dynamic range.

In another embodiment, the bipolar current multiplier apparatus can be associated with a preamplifier for a hard disk drive to calculate an output power associated with a power driver that controls a flying height of read/write heads of the hard disk drive. In another embodiment, the plurality of negative feedback loop circuits may include two negative feedback loops incorporated into the bipolar current multiplier apparatus. In yet another embodiment, bipolar devices may constitute bipolar transistors. In still other embodiments, each negative feedback loop among the plurality of negative feedback loop circuits is independent of one another and capable of being tuned separately from one another.

In other embodiments, adding at least one capacitor with respect to the plurality of negative feedback loop circuits can stabilize each negative feedback loop. In still other embodiments, an emitter current associated with at least one bipolar device among the plurality of bipolar devices is auto-adjustable via one or more of the negative feedback loop circuits and two or more bias currents. In another embodiment, each bipolar device among the plurality of bipolar devices may be a NPN device. In still other embodiments, a current source can provide electrical current to the plurality of negative feedback loop circuits and the plurality of bipolar devices, the current source comprising: a bipolar current source or a MOS current source.

In still another embodiment, a bipolar current multiplier can include a plurality of negative feedback loop circuits for compensating base current loss, a plurality of bipolar devices that communicates electronically with the plurality of negative feedback loop circuits, wherein the plurality of bipolar devices are responsive to base currents capable of being self-cancelled due to a presence of the plurality of negative feedback bop circuits, thereby ensuring that an output is stabilized over temperature and process variations while providing for a wide input dynamic range, and a preamplifier for a hard disk drive, wherein the bipolar current multiplier is associated with the preamplifier to calculate an output power associated with a power driver that controls a flying height of read/write heads of the hard disk drive.

In another embodiment, the plurality of negative feedback loop circuits can constitute two negative feedback loops incorporated into the bipolar current multiplier apparatus, the bipolar devices can be of bipolar transistors, and each negative feedback loop among the plurality of negative feedback loop circuits is independent of one another and capable of being tuned separately from one another.

In yet another embodiment, a method of configuring a bipolar current multiplier can be implemented. Such a method can include, for example, the steps of providing a plurality of negative feedback loop circuits for compensating base current loss, and configuring a plurality of bipolar devices to communicate electronically with the plurality of negative feedback loop circuits, wherein the plurality of bipolar devices are responsive to base currents capable of being self-cancelled due to a presence of the plurality of negative feedback loop circuits, thereby ensuring that an output is stabilized over temperature and process variations while providing for a wide input dynamic range.

In another embodiment, a step can be implemented for associating the bipolar current multiplier apparatus with a preamplifier for a hard disk drive to calculate an output power associated with a power driver that controls a flying height of read/write heads of the hard disk drive. In another embodiment, a step can be provided for configuring the plurality of negative feedback loop circuits to incorporate two negative feedback loops into the bipolar current multiplier. In yet another embodiment, a step can be provided for configuring the plurality of bipolar devices to comprise a plurality of bipolar transistors. In still another embodiment, a step can be provided for configuring each negative feedback loop among the negative feedback loop circuits to function independent of one another and such that each negative feedback loop is capable of being tuned separately from one another.

In another embodiment, a step can be provided for stabilizing each negative feedback loop among the plurality of negative feedback loop circuits by adding at least one capacitor with respect to the plurality of negative feedback loop circuits. In another embodiment, a step can be provided for configuring an emitter current associated with at least one bipolar device among the plurality of bipolar devices, wherein the emitter current is auto-adjustable by at least one negative feedback loop among the plurality of negative feedback loop circuits and at least two bias currents.

In still another embodiment, a step can be implemented for configuring each bipolar device among the plurality of bipolar devices to comprise a NPN device. In yet another embodiment, a step can be implemented for providing a current source electrical current to the plurality of negative feedback loop circuits and the plurality of bipolar devices, wherein the current source comprises: a bipolar current source or a MOS current source.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A bipolar current multiplier apparatus, comprising:
a plurality of negative feedback loop circuits for compensating base current loss; and
a plurality of bipolar devices that communicates electronically with said plurality of negative feedback loop circuits, wherein said plurality of bipolar devices are responsive to base currents capable of being self-cancelled due to a presence of said plurality of negative feedback loop circuits, thereby ensuring that an output is stabilized over temperature and process variations while providing for a wide input dynamic range.

2. The bipolar current multiplier apparatus of claim 1 wherein said bipolar current multiplier apparatus is associated with a preamplifier for a hard disk drive to calculate an output power associated with a power driver that controls a flying height of read/write heads of said hard disk drive.

3. The bipolar current multiplier apparatus of claim 1 wherein said plurality of negative feedback loop circuits comprises two negative feedback loops incorporated into said bipolar current multiplier apparatus.

4. The bipolar current multiplier apparatus of claim 1 wherein said plurality of bipolar devices comprises a plurality of bipolar transistors.

5. The bipolar current multiplier apparatus of claim 1 wherein each negative feedback loop among said plurality of negative feedback loop circuits is independent of one another and capable of being tuned separately from one another.

6. The bipolar current multiplier apparatus of claim 1 wherein each negative feedback loop among said plurality of negative feedback loop circuits is stabilized by adding at least one capacitor with respect to said plurality of negative feedback loop circuits.

7. The bipolar current multiplier apparatus of claim 5 wherein an emitter current associated with at least one bipolar device among said plurality of bipolar devices is auto-adjustable by at least one negative feedback loop among said plurality of negative feedback loop circuits and at least two bias currents.

8. The bipolar current multiplier apparatus of claim 1 wherein each bipolar device among said plurality of bipolar devices comprises a NPN device.

9. The bipolar current multiplier apparatus of claim 1 further comprising a current source providing electrical current to said plurality of negative feedback loop circuits and said plurality of bipolar devices, said current source comprising: a bipolar current source or a MOS current source.

10. A bipolar current multiplier, comprising:
a plurality of negative feedback loop circuits for compensating base current loss;
a plurality of bipolar devices that communicates electronically with said plurality of negative feedback loop circuits, wherein said plurality of bipolar devices are responsive to base currents capable of being self-cancelled due to a presence of said plurality of negative feedback loop circuits, thereby ensuring that an output is stabilized over temperature and process variations while providing for a wide input dynamic range; and
a preamplifier for a hard disk drive, wherein said bipolar current multiplier is associated with said preamplifier to calculate an output power associated with a power driver that controls a flying height of read/write heads of said hard disk drive.

11. The bipolar current multiplier of claim 10 wherein:
said plurality of negative feedback loop circuits comprises two negative feedback loops incorporated into said bipolar current multiplier apparatus;
said plurality of bipolar devices comprises a plurality of bipolar transistors; and
each negative feedback loop among said plurality of negative feedback loop circuits is independent of one another and capable of being tuned separately from one another.

12. A method of configuring a bipolar current multiplier, said method comprising:
providing a plurality of negative feedback loop circuits for compensating base current loss; and
configuring a plurality of bipolar devices to communicate electronically with said plurality of negative feedback loop circuits, wherein said plurality of bipolar devices are responsive to base currents capable of being self-cancelled due to a presence of said plurality of negative feedback loop circuits, thereby ensuring that an output is stabilized over temperature and process variations while providing for a wide input dynamic range.

13. The method of claim 12 further comprising associating said bipolar current multiplier apparatus with a preamplifier for a hard disk drive to calculate an output power associated with a power driver that controls a flying height of read/write heads of said hard disk drive.

14. The method of claim 12 further comprising configuring said plurality of negative feedback loop circuits to incorporate two negative feedback loops into said bipolar current multiplier.

15. The method of claim 12 further comprising configuring said plurality of bipolar devices to comprise a plurality of bipolar transistors.

16. The method of claim 12 wherein each negative feedback loop among said plurality of negative feedback loop circuits is independent of one another and capable of being tuned separately from one another.

17. The method of claim 12 further comprising stabilizing each negative feedback loop among said plurality of negative feedback loop circuits by adding at least one capacitor with respect to said plurality of negative feedback loop circuits.

18. The method of claim 16 further comprising configuring an emitter current associated with at least one bipolar device among said plurality of bipolar devices, wherein said emitter current is auto-adjustable by at least one negative feedback loop among said plurality of negative feedback loop circuits and at least two bias currents.

19. The method of claim 12 further comprising configuring each bipolar device among said plurality of bipolar devices to comprise a NPN device.

20. The method of claim 12 further comprising providing a current source electrical current to said plurality of negative feedback loop circuits and said plurality of bipolar devices, wherein said current source comprises: a bipolar current source or a MOS current source.
